(19) United States
(12) Patent Application Publication
(10) Pub. No.: US 2007/0071120 A1
(43) Pub. Date: Mar. 29, 2007

(54) Peak to average power reduction using channel state information

(76) Inventor: Shilpa Talwar, Santa Clara, CA (US)

Correspondence Address: INTEL CORPORATION;C/O INTELLEVATE, LLC, P.O. BOX 52050, MINNEAPOLIS, MN, 55402, US

(21) Appl. No.: 11/236,381

(22) Filed: Sep. 26, 2005

(51) Int. Cl. H04K 1/10

(52) U.S. Cl. 375/260

(57) ABSTRACT

Methods and systems for communicating in a wireless network include reducing the peak-to-average power ratio (PAPR) of orthogonal frequency division multiplexing (OFDM) subcarriers based on channel state information. Reducing the PAPR may include observing channel state information such as channel impulse response, interference or noise of a receive channel, selecting subcarriers for transmission likely to be detrimentally affected by the channel state and applying a known PAPR reduction technique, such as tone reservation PAPR reduction or tone injection PAPR reduction to the selected subcarriers. Various embodiments and variants are also disclosed.

### BACKGROUND OF THE INVENTION

Orthogonal frequency division multiplexing (OFDM) is an efficient modulation technique for data transmission over multi-path fading channels. It has been successfully adopted in several wired and wireless standards such as digital video broadcasting (DVB), digital serial line (DSL) and wireless local area network (WLAN) technologies. One issue with OFDM modulation is that it suffers from a high peak-to-average power ratio (PAPR) (also referred to as peak-to-average ratio (PAR)); namely, the peak signal amplitudes can often be significantly larger than the average signal amplitude. As a result, highly linear power amplifiers with a large dynamic range must be used or the signals peaks may be clipped at the amplifier's output. The use of highly linear amplifiers with large dynamic range which do not result in clipping may be quite costly and/or consume significant amounts of power.

On the other hand, clipping may cause in-band distortion which may reduce the signal-to-noise ratio (SNR) and/or cause out-of-band radiation resulting in interference to users in adjacent channels. Accordingly, a low cost, low power, low distortion solution to reducing PAR is desirable.

### BRIEF DESCRIPTION OF THE DRAWING

Aspects, features and advantages of the present invention will become apparent from the following description of the invention in reference to the appended drawing in which like numerals denote like elements and in which:

FIG. 1 is block diagram of a wireless network according to one embodiment of the present invention;

FIG. 2 is a flow diagram showing a method for PAPR reduction according to one embodiment of the invention;

FIG. 3 is a block diagram showing a conceptual layout of an Orthogonal Frequency Division Multiple (OFDM) system with PAPR reduction logic according to various embodiments; and

FIG. 4 is a block diagram of an example embodiment for an apparatus adapted to perform one or more of the methods of the present invention.

### DETAILED DESCRIPTION OF THE INVENTION

While the following detailed description may describe example embodiments of the present invention in relation to wireless networks utilizing Orthogonal Frequency Division Multiplexing (OFDM) or Orthogonal Frequency Division Multiple Access (OFDMA) modulation, the embodiments of present invention are not limited thereto and, for example, can be implemented using other modulation and/or coding schemes where suitably applicable. Further, while example embodiments are described herein in relation to wireless metropolitan area networks (WMANs), the invention is not limited thereto and can be applied to other types of wireless networks where similar advantages may be obtained. Such networks specifically include, but are not limited to, wireless local area networks (WLANs), wireless personal area networks (WPANs) and/or wireless wide area networks (WWANs).

The following inventive embodiments may be used in a variety of applications including transmitters of a radio system and transmitters of a wireless system, although the present invention is not limited in this respect. Radio systems specifically included within the scope of the present invention include, but are not limited to, network interface cards (NICs), network adaptors, mobile stations, base stations, access points (APs), gateways, bridges, hubs and cellular radiotelephones. Further, the radio systems within the scope of the invention may include cellular radiotelephone systems, satellite systems, personal communication systems (PCS), two-way radio systems, two-way pagers, personal computers (PCs) and related peripherals, personal digital assistants (PDAs), personal computing accessories and all existing and future arising systems which may be related in nature and to which the principles of the inventive embodiments could be suitably applied.

Peak reduction techniques have been the subject of much research and several approaches to peak reduction have been attempted including soft-clipping, phase-optimization, selective scrambling, block coding and adding virtual sub-carriers. In many of these schemes, an underlying mechanism for reducing PAR is to vary the amplitude and/or phase of pre-Fast Fourier Transform (FFT) subcarriers such that the FFT (which includes inverse FFT), output has reduced peaks. For example, in a virtual subcarrier approach, an empty subcarrier of an OFDM symbol may be used for adding artificial signals. These artificial signals may be optimized to yield lower peaks in the post-FFT OFDM symbol and a more detailed description of this type of technique is disclosed by Yang Jun et al. in “Reduction of the Peak-to-Average Power Ratio of the Multicarrier Signal via Artificial Signals” 2000 International Conference on Communication Technologies (ICCT2000), August 2000.

In another example, referred to as “tone reservation,” a small subset of subcarriers is set aside to similarly be optimized for PAR reduction. This type of technique can achieve 3 dB or 6 dB PAR reduction subject to a loss in data rate of less than 2% and 5% respectively. In yet another scheme, called “tone injection” known translating vectors may be added to pre-FFT data symbols to minimize transmitter PAR. As disclosed in “Peak Power Reduction for Multicarrier Transmission,” by Tellado, J. and Cioffi, J. M., at Globecom 1999, R10 de Janeio Brazil, Dec. 5-9, 1999, this method may achieve 6 dB PAR reduction without significant loss in data rate and with only a negligible increase in transmitter average power.

Regardless of the type of PAR reduction scheme used, subcarriers for transmission must be manipulated with data to reduce the peak-to-average power ratio. However, it has been observed that subcarriers used in PAR reduction do not carry data realizable by a receiver receiving the signal. Thus there should be some consideration given to which subcarriers are used in PAR reduction. However, the conventional techniques for PAR reduction fail to give any consideration to which subcarriers are used for PAR reduction. In other words, these techniques reserve, modify or inject subcarriers for PAR reduction without any consideration as to the importance or location of the subcarrier.

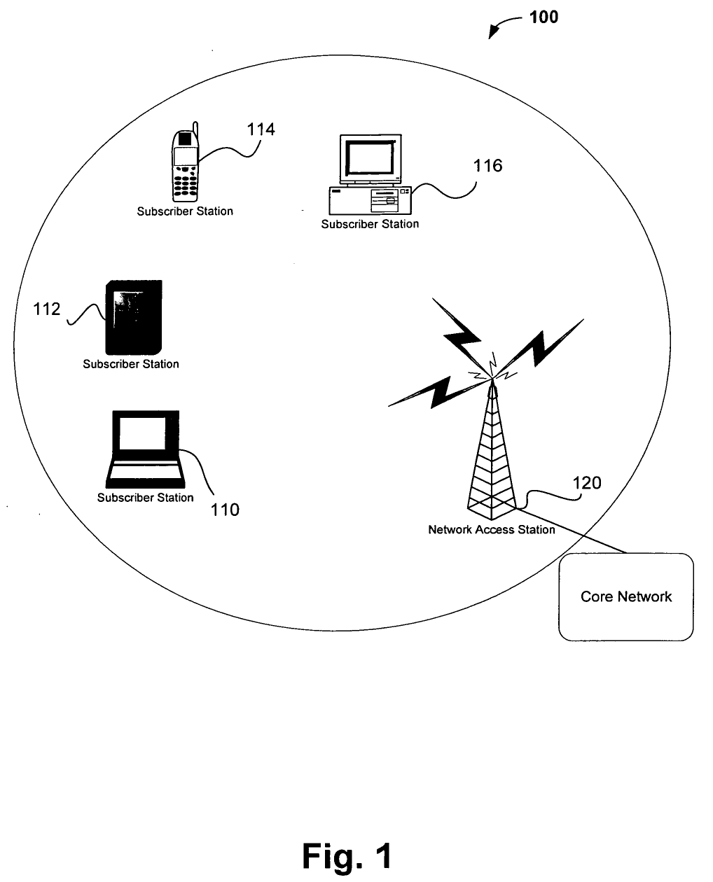

Turning to FIG. 1, a wireless communication system 100 according to one embodiment of the invention may include one or more user stations 110, 112, 114, 116 (also referred to as subscriber stations) and one or more network access stations 120 (also referred to as base stations). System 100 may be any type of wireless network such as a wireless metropolitan area network (WMAN), wireless wide area network (WWAN) or wireless local area network (WLAN) where subscriber stations 110-116 communicate with network access station 120 via an air interface.

System 100 may further include one or more other wired or additional wireless network devices as desired. In certain embodiments system 100 may communicate via an air interface utilizing multi-carrier modulation such as a using OFDM and/or OFDMA, although the embodiments of the invention are not limited in this respect. OFDM works by dividing up a wideband channel into a larger number of narrowband subcarriers or sub-channels, where a subchannel denotes one or more subcarriers. Each subcarrier or subchannel may be modulated separately depending on the signal interference to noise ratio (SINR) characteristics in that particular narrow portion of the band. In operation, transmission may occur over a radio channel which, in some networks, may be divided into intervals of uniform duration called frames composed of a plurality of OFDM and/or OFDMA symbols, each of which is composed of several subcarriers. There are many different physical layer protocols which may be used to encode data on the subcarriers and a channel may carry multiple service flows of data to and from base station 120 and user stations 110-116.

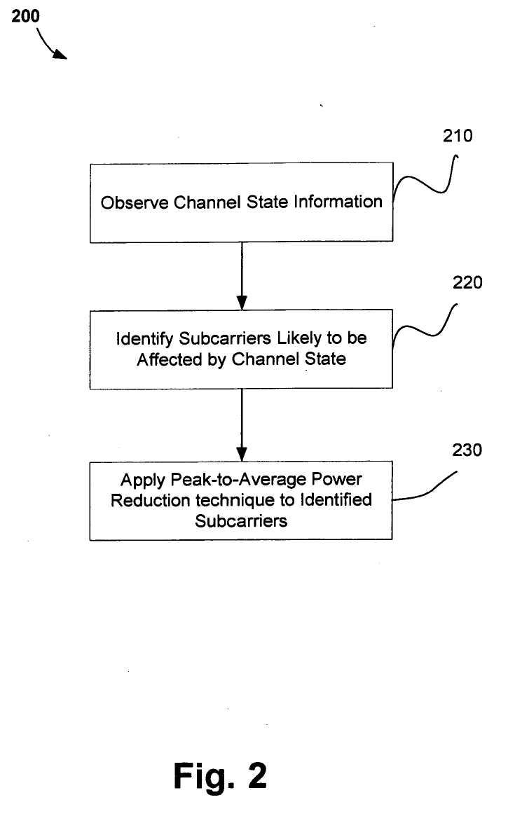

Turning to FIG. 2 a method 200 of communicating in a wireless network may generally include reducing a peak-to-average power ratio (PAPR) using one or more subcarriers or subchannels selected based on information which concerns a communication channel, generically referred to herein as channel state information.

In one embodiment, method 200 includes observing 210 channel state information, identifying 220 subcarriers for transmission likely to be detrimentally affected by the channel state; and applying 230 a PAPR reduction technique to one or more of the identified subcarriers. Generally, a frequency-selective multi-path channel will inherently have some subcarriers that have a very low SNR ratio. If a transmitting device has knowledge of the location of these subcarriers, they can be used as virtual subcarriers, reserved tones, or as candidates for tone injection using known PAR reduction techniques instead of subcarriers having a good SNR.

The observed channel state information may include information which describes, or has an impact, on the communication channel such as the channel impulse response, the channel interference (e.g., interference frequency characteristics), the noise levels present in the channel and the like. Channel impulse response is a measurable response by a radio communication channel when an electromagnetic impulse is transmitted over the air. The radio propagation channel acts as a time and spatial varying filter which can distort the signal. The purpose of channel impulse measurements is to quantify the varying characteristics of the communication channel along both the time and spatial dimensions.

For example, in one embodiment, assume a generic signal received at a device X(f)ₖ is represented by the following:
X(f)ₖ=H(f)ₖ*S(f)ₖ+I(f)ₖ+N(f)ₖ

where H(f)ₖ=the channel frequency response, S(f)ₖ=the data signal transmitted, I(f)ₖ=the interference and N(f)ₖ=noise at each subcarrier k, where k=1-N subcarriers.

The device may include logic to identify the SNR or SINR of the channel for each subcarrier k, and the subcarriers with the lowest SNR or SINR may be selected as candidates for use in PAPR reduction of a transmit signal. There are numerous signal representations and/or algorithms to determine the SNR or SINR of a signal and the inventive embodiments are not limited in this respect.

In various embodiments, channel state information may alternatively or additionally include effects on the communication channel due to the hardware of the communications device itself, referred to herein as hardware impairments. For example, the channel may be affected by carrier-leakage which tends to distort subcarriers near direct current (DC) levels.

In certain embodiments, the channel state information may be observed 210 based on a received signals due to the reciprocal characteristics inherent in a time-division duplex (TDD) communications channel. In other embodiments not using TDD, e.g., frequency division duplexing (FDD), knowledge of the channel is often available from existing mechanisms for feeding back channel information to a transmitter. For example, mechanisms used to support functions such as link adaptation, transmit pre-coding, sub-channel allocation (in OFDMA systems), interference avoidance and the like, may be used to provide channel state information to select subcarriers for PAR reduction. In systems which use both TDD and FDD, either one, or a combination, of the foregoing techniques may be used to identify subcarriers for PAR reduction.

In any case, with knowledge about the state of the communication channel, a transmitting device may be able to identify portions of a transmission, and corresponding subcarriers, which are likely to be detrimentally affected by the communication channel. For example, if the SNR of particular subcarriers is likely to be low due to interference, noise or fading of communications channel, hardware impairment, or other factor, the transmitting device may select 220 one or more of those subcarriers for applying 230 a PAPR technique, as any data modulated on these subcarriers would likely not be discernable by a receiver anyway.

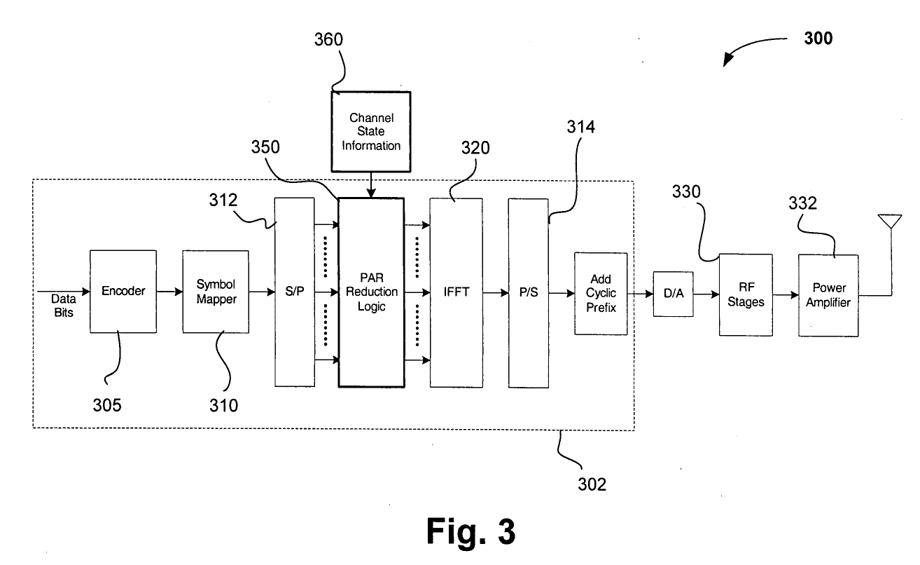

Turning to FIG. 3, a communication device 300 according to various embodiments may include a baseband processing circuit 302 for constructing and/or transmitting OFDM and/or OFDMA signals. Device 300 may include elements similar to existing devices such as a data encoder 305, symbol mapper 310, serial-to-parallel (SP) and/or parallel-to-serial (PS) interfaces 312, 314, Fourier Transform logic 320, a radio frequency (RF) front end 330 and/or one or more power amplifiers 332 if desired. However, in embodiments of the present invention, circuit 302 may include PAPR logic 350 to identify pre-transform subcarriers based on channel state information 360 and to perform peak-to-average ratio reduction on select subcarriers according to one or more of the methods previously described.

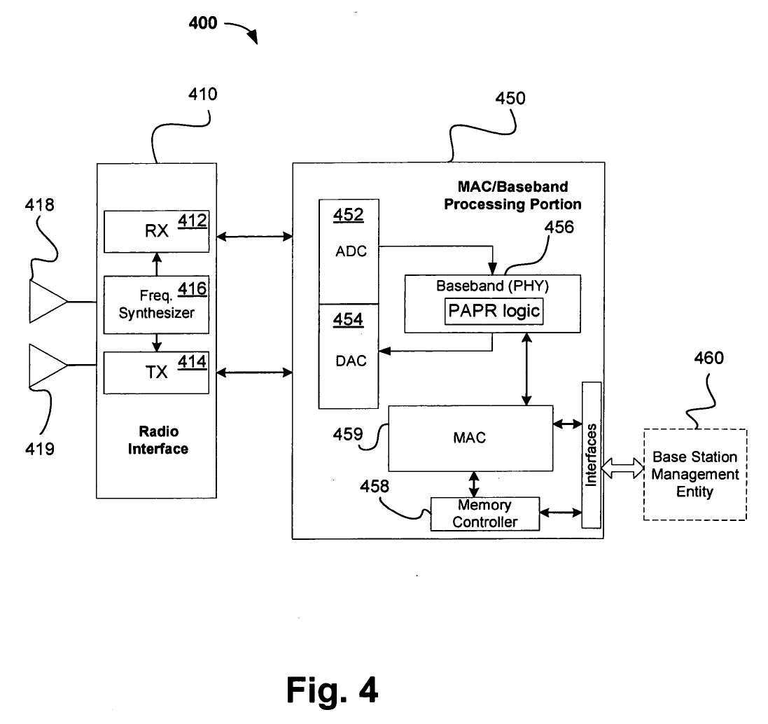

Referring to FIG. 4, an apparatus 400 for use in a wireless network may include a processing circuit 450 adapted to reduce PAPR based on channel state information as described above. In certain embodiments, apparatus 400 may generally include a radio frequency (RF) interface 410 and a baseband and medium access controller (MAC) processor portion 450 although the embodiments are not limited in this respect.

In one example embodiment, RF interface 410 may be any component or combination of components adapted to send and/or receive multi-carrier modulated signals (e.g., OFDM or OFDMA) although the inventive embodiments are not limited to any particular modulation scheme. RF interface 410 may include a receiver 412, transmitter 414 and frequency synthesizer 416. Interface 410 may also include bias controls, a crystal oscillator and/or one or more antennas 418, 419 if desired. Furthermore, RF interface 410 may alternatively or additionally use external voltage-controlled oscillators (VCOs), surface acoustic wave filters, intermediate frequency (IF) filters and/or radio frequency (RF) filters as desired. Various RF interface designs and their operation are known in the art and the description thereof is therefore omitted.

In some embodiments interface 410 may be configured to be compatible with one or more of the Institute of Electrical and Electronics Engineers (IEEE) 802.11 standards for WLANs and/or 802.16 standards for broadband WMANs, although the embodiments are not limited in this respect.

Processing portion 450 may communicate with RF interface 410 to process receive/transmit signals and may include, by way of example only, an analog-to-digital converter 452 for digitizing received signals, a digital to analog converter 454 for analog conversion of transmissions, a baseband processor 456 for physical (PHY) link layer processing of respective receive/transmit signals (e.g., similar to circuit 302 in FIG. 3), and one or more memory controllers 458 for managing read-write operations from one or more internal and/or external memories (not shown). Processing portion 450 may also include or be comprised of a processing circuit 459 for medium access control (MAC)/data link layer processing.

In certain embodiments of the present invention, baseband processing circuit 456 may include the PAPR reduction logic as described previously. Alternatively or in addition, MAC circuit 459 may share processing for certain of these functions or perform these processes independent of baseband processing circuit 456. MAC and PHY processing may also be integrated into a single component if desired. Apparatus 400 may also include, or interface with, a station management entity 460 which may control or assist in scheduling traffic, quality of service (QoS) attributes and/or other features.

Apparatus 400 may be, for example, a wireless base station, wireless router, user station and/or network interface card (NIC) or network adaptor for computing or communication devices. Accordingly, the previously described functions and/or specific configurations of device 300 or apparatus 400 could be included or omitted as suitably desired.

The components and features of device 300 or apparatus 400 may be implemented using any combination of discrete circuitry, application specific integrated circuits (ASICs), logic gates and/or single chip architectures. Further, the features of apparatus 300, 400 may be implemented using microcontrollers, programmable logic arrays and/or microprocessors or any combination of the foregoing where suitably appropriate. Thus, as used herein, the terms circuit and logic could mean any type of hardware, firmware or software implementation and the inventive embodiments are not limited to any specific architecture implementation.

It should be appreciated that the examples shown in the block diagrams of FIGS. 3 and 4 represent only functionally descriptive examples of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Embodiments of the present invention may be implemented using single input single output (SISO) architectures using a single dipole antenna. However, as shown in FIG. 4, certain implementations may use multiple-input multiple-output (MIMO), SIMO or MISO architectures utilizing multiple antennas (e.g., 418, 419) for transmission and/or reception. Further, embodiments of the invention may utilize multi-carrier code division multiplexing (MC-CDMA) multi-carrier direct sequence code division multiplexing (MC-DS-CDMA) or any other existing or future arising modulation or multiplexing scheme compatible with the features of the inventive embodiments.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless network, the method comprising:
reducing a peak-to-average power ratio (PAPR) of a transmission using of one or more subcarriers selected based on channel state information.

2. The method of claim 1 wherein reducing the PAPR comprises:
observing channel state information;
identifying subcarriers for transmission likely to be detrimentally affected by the channel state; and
applying a PAPR reduction technique to one or more of the identified subcarriers.

3. The method of claim 2 wherein the PAPR reduction technique comprises a tone reservation PAPR reduction.

3. The method of claim 2 wherein the PAPR reduction technique comprises a tone injection PAPR reduction.

5. The method of claim 2 wherein the PAPR reduction technique comprises adding artificial signals to the one or more identified subcarriers.

6. The method of claim 1 wherein the channel state information comprises information relating to a communication channel including at least one of channel impulse response, interference, noise level or hardware impairments.

7. The method of claim 1 wherein the wireless network uses orthogonal frequency division multiplexing (OFDM).

8. The method of claim 1 wherein the wireless network uses time-division-duplexing (TDD) protocols and wherein the channel state information is based on reciprocity of a TDD channel.

9. The method of claim 1 wherein the wireless network uses frequency division duplexing (FDD) and wherein the channel state information is based on channel feedback signals.

10. The method of claim 1 wherein the wireless network comprises a broadband wireless network.

11. An apparatus for wireless communications, the apparatus including:
a peak-to-average power ratio (PAPR) reduction circuit to reduce a PAPR of a transmission using one or more subcarriers selected based on channel state information.

12. The apparatus of claim 11 wherein the PAPR reduction circuit is included in a physical (PHY) layer circuit to modulate transmissions using orthogonal frequency division multiplexing (OFDM).

13. The apparatus of claim 11 wherein the PAPR reduction circuit includes an input to receive the channel state information and based on inputted channel state information, the PAPR circuit identifies subcarriers for transmission which are likely to be detrimentally affected by the channel state and applies a PAPR reduction technique at least to one or more of the identified subcarriers.

14. The apparatus of claim 13 wherein the PAPR reduction technique comprises a tone reservation PAPR reduction.

15. The apparatus of claim 13 wherein the PAPR reduction technique comprises tone injection PAPR reduction.

16. The apparatus of claim 11 wherein the channel state information comprises information about a state of a communication channel including at least one of channel impulse response, interference, noise level or carrier leakage.

17. The apparatus of claim 11 wherein the apparatus comprises a mobile station.

18. The apparatus of claim 11 wherein the apparatus comprises a base station.

19. A system for communicating in a wireless network, the system comprising:
a physical (PHY) layer processing circuit including peak-to-average power ratio (PAPR) reduction logic to reduce a PAPR of an OFDM/OFDMA transmission, wherein one or more subcarriers are selected for PAPR based on a likelihood to be detrimentally affected by one or more conditions in the wireless network; and
at least one dipole antenna directly or indirectly coupled to the PHY layer processing circuit to radiate signals from the PHY layer processing circuit as electromagnetic waves.

20. The system of claim 19 further comprising:
a media access controller (MAC) circuit coupled to the PHY layer processing circuit to assemble frames to be modulated by the PHY layer processing circuit.

21. The system of claim 19 wherein the one or more subcarriers are selected based on at least one of a channel impulse response, interference, noise or hardware impairments of the wireless network.

22. The system of claim 19 wherein the PAPR reduction of one or more selected subcarriers is performed using one of a tone reservation, tone injection or virtual subcarrier technique.

23. An article of manufacture having stored thereon machine readable instructions that when executed by a processing platform result in:
reducing a peak-to-average power ratio (PAPR) of a transmission using one or more subcarriers selected based on channel state information.

24. The article of claim 23 wherein reducing the PAPR comprises:
observing channel state information;
identifying subcarriers for transmission likely to be detrimentally affected by the channel state; and
applying a PAPR reduction technique to one or more of the identified subcarriers.

25. The article of claim 24 wherein the PAPR reduction technique comprises one of a tone reservation PAPR reduction, a tone injection PAPR reduction or a virtual subcarrier PAPR reduction.

26. The article of claim 23 wherein the channel state information comprises information regarding one or more of a channel impulse response, interference, noise or hardware impairments.
